(19) United States
(12) Patent Application Publication
(10) Pub. No.: US 2018/0171209 A1
(43) Pub. Date: Jun. 21, 2018

(54) Enhancing SAG Resistance via Selection of Solids Based on Size and Material Composition

(71) Applicant: M-I L.L.C., Houston, TX (US)

(72) Inventor: Carol Chong Larson, Houston, TX (US)

(21) Appl. No.: 15/846,178

(22) Filed: Dec. 18, 2017

Related U.S. Application Data
(60) Provisional application No. 62/437,185, filed on Dec. 21, 2016.

(51) Int. Cl. C09K 8/508; C09K 8/502; E21B 33/138

(52) U.S. Cl. CPC C09K 8/5083; E21B 33/138; C09K 8/502

(57) ABSTRACT

A wellbore fluid may include a base fluid and a blend of weighting agents having different particle sizes and/or specific gravity suspended in the base fluid. A method of treating a wellbore is also described. A wellbore fluid may also include a base fluid comprising a curable polymeric solution, and a blend of particles having different particle sizes and/or specific gravity suspended in the base fluid, wherein the blend of particles is selected to maintain suspension of the solid particles in the wellbore fluid while the wellbore fluid is static during curing of the curable polymeric solution.

### CROSS REFERENCE TO RELATED APPLICATIONS

This application claims the benefit of priority to U.S. Provisional Patent Application 62/437,185, filed on Dec. 21, 2016, the entire content of which is incorporated herein by reference.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

It is known in the art that during the drilling process, weighting agents, as well as cuttings, can create sedimentation or “sag” that can lead to a multitude of well-related problems such as lost circulation, loss of well control, stuck pipe, and poor cement jobs. The sag phenomenon arises from the settling out of particles from the wellbore fluid. This settling out causes major localized variations in mud density or “mud weight,” both higher and lower than the nominal or desired mud weight. The phenomenon generally arises when the wellbore fluid is circulating bottoms-up after a trip, logging or casing run. Typically, light mud is followed by heavy mud in a bottoms-up circulation.

Sag is influenced by a variety of factors related to operational practices or drilling fluid conditions such as: low-shear conditions, drill string rotations, time, well design, drilling fluid formulation and properties, and the mass of weighting agents. The sag phenomenon tends to occur in deviated wells and is most severe in extended-reach wells. For drilling fluids utilizing particulate weighting agents, differential sticking or a settling out of the particulate weighting agents on the low side of the wellbore is known to occur.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a wellbore fluid that includes a base fluid and a blend of weighting agents having different particle sizes and/or specific gravity suspended in the base fluid.

In another aspect, embodiments of the present disclosure relate to a wellbore fluid that includes a base fluid containing a curable polymeric solution, and a blend of particles having different particle sizes and/or specific gravity suspended in the base fluid, where the blend of particles is selected to maintain suspension of the solid particles in the wellbore fluid while the wellbore fluid is static during curing of the curable polymeric solution.

In yet another aspect, embodiments disclosed herein relate to a method of treating a wellbore that includes pumping a wellbore fluid into the wellbore, the wellbore fluid including a base fluid, and a blend of weighting agents having different particle sizes and/or specific gravity suspended in the base fluid.

Other aspects and advantages of the claimed subject matter will be apparent from the following description and the appended claims.

### DETAILED DESCRIPTION

Generally, embodiments disclosed herein relate to wellbore fluids that enhance sag resistance and methods of using the same. More specifically, embodiments disclosed herein relate to wellbore fluids for downhole applications formed of a base fluid and a blend of particles, such as weighting agents having different particle sizes and/or specific gravity suspended in the base fluid The inventors of the present disclosure have found that a blend of particles such as weighting agents having different particle sizes and/or specific gravity suspended in the base fluid may be selected in such a manner to maintain suspension of the solid particles in the wellbore fluid under either dynamic or static conditions.

Particle size and density determine the mass of particles such as weighting agents, which in turn correlates to the degree of sag. Thus, it follows that lighter and finer particles, theoretically, will sag less. However, reducing weighting agent particle size may cause an undesirable increase in the fluid's viscosity, particularly its plastic viscosity (generally understood to be a measure of the internal resistance to fluid flow that may be attributable to the amount, type or size of the solids present in a given fluid). It has been theorized that this increase in plastic viscosity attributable to the reduction in particle size—and thereby increasing the total particle surface area—is caused by a corresponding increase in the volume of fluids, such as water or drilling fluid, adsorbed to the particle surfaces. Thus, particle sizes below 10 μm have conventionally been disfavored.

Because of the mass of the weighting agent, various additives are often incorporated to produce a rheology sufficient to allow the wellbore fluid to suspend the material without settlement or “sag” under either dynamic or static conditions. Such additives may include a gelling agent, such as bentonite for water-based fluid or organically modified bentonite for oil-based fluid. A balance exists between adding a sufficient amount of gelling agent to increase the suspension of the fluid without also increasing the fluid viscosity resulting in reduced pumpability. One may also add a soluble polymer viscosifier such as xanthan gum to slow the rate of sedimentation of the weighting agent. However, as more gellant is added to increase the suspension stability, the fluid viscosity (plastic viscosity and/or yield point) increases undesirably resulting in reduced pumpability. This is also the case if a viscosifier is used to maintain a desirable level of solids suspension.

However, by using a combination or blend of particles such as weighting agents, a wellbore fluid that has an improved sag performance as compared to conventional fluids may be achieved, while maintaining comparable rheological properties. In particular, the rheology is adequate to allow the fluid to suspend the dense weighting agent without settlement or “sag” under either dynamic or static conditions. As it will be described later in greater detail, this property is particularly desirable in the case of a fluid containing a curable polymeric solution, such as a weighted curable lost circulation pill, that is cured in situ in the wellbore, where other additives like gelling agents or other chemical additives cannot be used. During such curing, risk of sag is conventionally high and can be detrimental, particularly when the fluid column is supporting against a fragile formation (having or susceptible to fluid loss events). However, it is also intended that the blend of weighting agents may also be used in other wellbore fluid that do not necessarily have a polymeric component that cures in situ, such as spacers, cementing fluid, drilling fluids, etc. where the fluids that may remain static for periods of time receive benefit of the improved sag performance while maintaining rheological properties.

The wellbore fluids of the present disclosure incorporate a blend of particles, (suspension particles) that can be dispersed or suspended in a base fluid. Upon dispersion or suspension in the base fluid, the particles form a stable suspension and do not readily settle out. The resulted suspension exhibits a low viscosity under shear, facilitating pumping and minimizing the generation of high pressures. Without being bound by the theory, it is believed that blends or combinations of different particle sizes and/or specific gravities having certain ratios between the particle sizes and/or specific gravities may provide enhanced sag resistance.

Low viscosity of a base fluid may limit solids suspension which is an essential fluid property for oil field applications, storage and transportation. Thus, by considering the particle size and/or the specific gravity of the particles suspended in the base fluid, solid suspension may be enhanced by using an optimized ratio of small particles in combination with large particles or light particles in combination with heavy particles. For example, selecting a lower density material may use more solids in the base fluid, which may increase solids interaction such as van der Waals interactions, causing viscosity of the fluid. Selecting a smaller particle size will slow the settling rate of the solid. Finding an optimized ratio of small and large particles may provide the desired fluid viscosity, as well as maintain suspension of solids without the addition of chemical additives. The optimized ratio depends on the final properties of the wellbore fluid. For example, high volumes of light, small particles, to aid in suspension will result in a more viscous fluid, therefore, slowing down the settling rate of heavier, larger particles. As described later in greater detail, the use of an optimized ratio of small and large particles or light particles in combination with heavy particles suspended in the base fluid may prevent loss of large particles that may fall out of the solution, as well as mitigate/avoid an increase in the viscosity of the fluid that may result when small particles are used.

According to embodiments, the particles may have a particle size distribution other than a monomodal distribution. That is, the particles as described herein may have a particle size distribution that may be bimodal. It is also envisioned that the particles used for the preparation of the blends as described herein may have a tri- or other multimodal distribution.

As described herein, the blends of particles may be prepared using at least two different modes of particles that vary in size and/or specific gravity. In various embodiments, the blend of particles may include a first mode of small particles and a second mode of large particles. In such embodiments, the ratio, by volume, of the first mode of small particles to the second mode of large particles, may range from about 40:60 to about 90:10, where the lower limit can be any of 40:60, 50:50, or 55:45 and the upper limit can be any of 70:30, 80:20 or 90:10, where any lower limit can be used with any upper limit. However, such ratios may vary as the lower limit is determined by the minimal allowed settling rate, while the upper limit is determined by the highest allowed plastic viscosity (PV) and rheological properties. For example, in one embodiment, the minimum percentage of the first mode of particles present in the fluid may be 40%. In such an embodiment, the minimum percentage of the second mode of particles may be 60%. However, other combinations are possible and the ratio between the first mode of small particles and the second mode of large particles may be tailored depending on the final density of the wellbore fluid, the size difference of the two particles, as well as the initial viscosity of the base/carrier fluid.

For example, for a wellbore fluid with a density of 12 pounds per gallon, the solids ratio between the first mode of small particles (having a size of 2 μm) and a second mode of large particles (having a size of 60 μm) may be 70:30 by volume. Such a ratio may provide for optimal suspension and rheological properties. In such embodiment, the specific gravities of both modes may be different. If a wellbore fluid with a higher density is desired, then a higher percentage of large particles may be added. For example, for a wellbore fluid with 14 pounds per gallon density, the percentage of the second mode of large particles may be increased to 40%, while the first mode of small particles may be decreased to 60%. In such embodiments, the second mode of large particles used may have a particle size larger than 20 to 3000 μm. In such embodiment, the small particles (used as weighting agents) may have a particle size ranging from about 1 to about 20 μm. One of ordinary skill in the art would appreciate that depending on the desired density, the ratio of the first mode of small particles and the second mode of large particles may vary. Thus, it will be understood by those skilled in the art that numerous variations or modifications from the described embodiments may be possible. The particles may be ground to the desired size by a variety of methods. As described herein, the particles used for preparation of the blends are not limited to any particular shape.

According to the present embodiments, the particles used for the preparation of blends may include a variety of compounds, the identity of which may be understood by one of ordinary skill in the art having the benefit of the present disclosure. The particles that have shown utility in the present disclosure have a size ranging from about 30 nm to about 3000 μm. Such particles may be selected from the group of weighting agents and/or other inert solid materials used as suspension aids. Such particles may be selected from the group of minerals, coated solids or synthetic compounds such as ceramic proppants. For example, the blend of particles suspended in the base fluid may be prepared using weighting agents that have different particle size and/or specific gravity. It is also envisioned that the weighing agents may be blended with inert solid materials used as suspension aids, where both the weighting agents and the inert solid materials may have a different particle size and/or specific gravity.

As defined herein, weighting agents are typically inert solids that have a specific gravity of 2.1-5.3 g/cm³. Inert solid materials used as suspension aids are not added for increasing the density of the fluid as in the case of silica or glass spheres/beads and thus may have a lower specific gravity. Suspension aids can also be used to increase compressive strength. Further, as defined herein, particles having nanometer scale, such as any particle having a size less than 1 μm is considered too small to be used as a weighting agent, and instead would be used as a suspension aid.

In various embodiments, the wellbore fluids as described herein are prepared by mixing a first mode of particles having a particle size that ranges in the nanometer scale with a second mode of particles having a particle size that ranges in the micrometer scale. It is also envisioned that the first and the second modes of particles used for the preparation of the wellbore fluid may have a particle size ranging in the same scale, micrometer or nanometer scale, where the size of the first mode of particles is selected in such a manner that is smaller than the size of the second mode of particles.

As noted above, the weighting agents of the present disclosure may be blended with particles selected from the group of inert solid materials that are not weighting agents, but aid in suspension, having a specific gravity of less than 2.1 g/cm³. In such embodiments, the particle size of the inert solid materials that may aid in suspension may range from about 30 nm to about 1 μm, where the lower limit can be any of 30 nm, 50 nm, or 70 nm and the upper limit can be any of 100 nm, 500 nm or 1 μm, where any lower limit can be used with any upper limit. However, particles having a larger particle size but which have a specific gravity less than 2.1 g/cm³ may also be used as suspension aids.

In one or more embodiments, the blend of particles is prepared using weighting agents (alone or in combination with suspension aids). In such embodiments, the weighting agent may be selected from one or more of the materials including, for example, barium sulphate (barite), calcium carbonate (calcite), dolomite, ilmenite, hematite or other iron ores, olivine, siderite, manganese oxide, and strontium sulphate. One having ordinary skill in the art would recognize that selection of a particular material may depend largely on the density of the material as typically, the lowest wellbore fluid viscosity at any particular density is obtained by using the highest density particles. In one or more embodiments, the weighting agent may have a size ranging from about 1 μm to about 3000 μm, where the lower limit can be any of 1 μm, 10 μm, or 20 μm and the upper limit can be any of 250 μm, 500 μm or 3000 μm, where any lower limit can be used with any upper limit.

In one or more embodiments, each mode of particles in the blend of weighting agents or in the blend of weighting agents and inert solid materials, may have a different specific gravity. In such embodiments, the particles may have the same size, or may have different sizes. For example, a minimum percentage of 40% of the first mode of particles having a specific gravity SG1 may be blended with a minimum percentage of 60% of the second mode of particles having a specific gravity SG2. The percentages may be modified depending on the desired density of the wellbore fluid. It is also envisioned that the particles may have a bimodal particle size distribution. In such a case, particles having different particle sizes and different specific gravities may be used for the formulation of the wellbore fluids as described herein. For example, a second mode of particles may have the particle size and the specific gravity higher than the ones of the first mode of particles. However, as noted above, the selection of the size and/or specific gravities of the first and second modes of particles depends on the desired properties of the wellbore fluid. As used herein, “specific gravity” refers to the ratio of density of a particular substance to the density of a reference substance (typically water for fluids). Specific gravity is calculated based on densities at constant pressure and temperature.

In some embodiments, the weighting agents particles may be blended with inert solid materials and may have specific gravity that ranges from about 2.1 g/cm³ to about 5.3 g/cm³, where the lower limit can be any of 2.1 g/cm³, 2.2 g/cm³ or 2.5 g/cm³ and the upper limit can be any of 5.1 g/cm³, 5.2 g/cm³ or 5.3 g/cm³, where any lower limit can be used with any upper limit. In yet another embodiment, the blends may be prepared using particles with low specific gravity (SG). The exact density used may depend on a number of factors, included, but not limited to, particle size, particle cost, particle availability and the like. According to the present disclosure, the first mode of small particles and the second mode of large particles used for the preparation of the blends may be made of the same material, or different materials. Particles having a specific gravity as described above may allow wellbore fluids to be formulated to meet most density requirements yet have a particulate volume fraction low enough for the fluid to be pumpable.

The blends of particles as described herein, such as blends of weighting agents, or blends of weighting agents and inert solid materials used as suspension aids, may generate suspensions or slurries that may show a reduced tendency to sediment or sag during the curing of a polymer, producing lower rheological values. It is the combination of different sizes of particles and/or different specific gravity that reconciles the two objectives of lower viscosity and minimal sag.

According to the present disclosure, the base fluid may optionally include a curable polymeric solution. It is also envisioned that the curable polymeric solution may act as a base fluid itself. According to various embodiments, the base fluid containing the curable polymeric solution, or the curable polymeric solution itself may be weighted with solid particles. For example, a curable polymeric solution may be weighted with a blend of weighting agents and inert solid materials used as suspension aids, wherein the weighting agents and the inert solid materials are selected to maintain suspension of the solid particles in the wellbore fluid while the wellbore fluid is static during curing of the curable polymeric solution. The amount of the curable polymeric solution (such as a loss circulation pill) used may be determined by the well profile. The weighted base fluid containing the curable polymeric solution or the weighted curable polymeric solution itself may be pumped into the wellbore as a lost circulation pill, for example, to cure fluid loss to the formation. In such embodiment, the lost circulation pill may be separated from other fluids (such as drilling fluids) by a spacer present in the fluid column. In this instance, it is also envisioned that the spacer wellbore fluid may also contain a blend of weighting agents, as described herein, as the fluid remains static in the well while the curable polymeric solution, such as a curable lost circulation pill, cures.

Polymerization of the curable polymeric solution, such as a lost circulation pill, may involve, for example, thermal polymerization, catalyzed polymerization, initiated polymerization or combinations thereof. The curable polymeric solutions (that have shown utility in the present disclosure are selected from the group of thermosetting polymers. As described herein, the thermosetting polymers may be activated via radical polymerization (such as vinyl acrylate with organic peroxide), temperature (such as block isocyanates) or pH (such as sodium silicate with zinc).

In one or more embodiments, a polymer formulation non-weighted or weighted with solid particles as described above may be pumped into a selected region of the wellbore (such as an open-hole or cased wellbore) needing consolidation, strengthening, fluid-loss reduction, etc., and allowed to cure, forming a polymeric mass or a network which stabilizes the formation and the wellbore as a whole. For example, when loss of a wellbore fluid is being experienced from the formation, a curable polymeric solution may be emplaced (such as by bullheading) directly into the region of the well experiencing losses. As described above, such curable polymeric solutions may be already weighted to the same weight as the current wellbore fluids. Ideally, weighted spacers free of a curable polymer may be used to prevent large interfaces so the weighted curable polymeric solution (such as a loss circulation pill) may fully cure and provide strength. Solids suspension in such a pill (typically weighted) may provide uniform curing of the loss circulation pill.

As described above, the blends of particles of the present disclosure may reduce sagging that may occur under dynamic or static conditions of the wellbore fluid. In some embodiments, sagging may occur during curing the polymeric solution, while the fluid is static. In such embodiments, the quantity of such solid particles added, and implicitly the ratio of small and large particles and/or light and heavy, may depend upon the desired density of the final composition, as well as of the make up of the curable polymeric solution. For example, some polymer blends are thicker and therefore may need less solids to enhance the sagging. As a result, the ratio may change depending on the desired amount of solids.

However, it will be understood by those skilled in the art that the present disclosure may be practiced without these details and that numerous variations or modifications from the described embodiments may be possible.

Curable Polymers

Curable polymers may be cured or cross-linked to a higher molecular weight bulk material which may have desirable mechanical and chemical properties. Such properties may include hardness, durability, and resistance to chemicals.

In some embodiments, the polymer is an epoxy vinyl ester resin of the following formula:

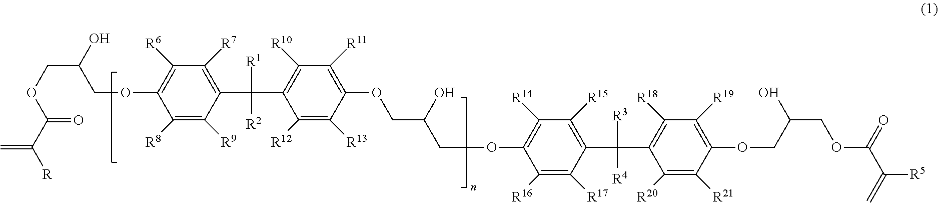

wherein R and R¹-R⁵ may be CH3- or H,R⁶-R²¹ may be H or Br, and n may be 1-5. One of ordinary skill in the art may appreciate that the epoxy vinyl ester resin may be formed from esterification of bisphenol a. In other embodiments, the reactive polymer may be a vinyl ester polymer formed from the esterification of an epoxy resin with an unsaturated carboxylic acid, modified epoxy acrylates, modified epoxy vinyl esters, unsaturated polyesters, or combinations thereof. The epoxy resin being esterified may be formed from bisphenol a type, bisphenol f type, novolac, and aliphatic epoxies. Related derivatives may also be used as long as they are polymerizable through a free radical polymerization reaction. As used herein, modified means hybrid polymers or polymers that are extended with other molecules that are not bisphenol derivatives.

Depending on the particular application, it may be desirable to form a composite to treat weak or permeable formations. Liquid polymer solutions are particularly well suited for downhole applications because they are pumpable in their uncured state. In various embodiments, the liquid polymer solutions may be used in its neat form, may be dissolved in a solvent, or may be dispersed or emulsified in a non-miscible phase, and a curing agent may be added to the liquid solution to form a composite.

For example, such a liquid polymer solution may be pumped downhole to traverse a loosely consolidated formation in the wellbore. An initiator and desired additives may then be pumped downhole to initiate curing of the liquid polymer solution to form a strongly bonded matrix that may efficiently coat the loosely consolidated formation, therefore controlling the production of sand grains from the treated zones. This treatment may serve to strengthen the wellbore and reduce debris which may cause wear to downhole tools.

The curable polymer may be used in an amount ranging from about 10 to about 90 weight percent, based on the total weight of the composite, from about 20 to about 80 weight percent in other embodiments, and from about 30 to about 70 weight percent in yet other embodiments.

In some embodiments, the curable polymer may be a combination of a first polymer of at least one epoxy vinyl ester resin having formula (1) described above and a second polymer of at least one polymer capable of polymerizing through a free radical polymerization reaction from the group of epoxy acrylates, modified epoxy acrylates, epoxy precursors, modified epoxy vinyl esters, unsaturated polyesters, urethane acrylates, urethane (meth)acrylates, polyester acrylates or combinations thereof.

In some embodiments, the second polymer is a urethane acrylate resin of the following formula:

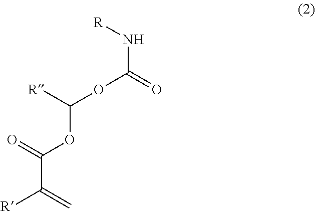

wherein R may be an aliphatic or aromatic, R′ or R″ may be hydrogen or methyl. The urethane acrylate is derived from hydroxyl functional (meth) acrylate and isocyanate.

The first polymer may be used in an amount ranging from about 0 to about 100 weight percent, based on the total weight of the curable polymer, from about 10 to about 90 weight percent in other embodiments, and from about 20 to about 80 weight percent in yet other embodiments. The second polymer may be used in an amount ranging from about 0 to about 100 weight percent, based on the total weight of the curable polymer, from about 10 to about 90 weight percent in other embodiments, and from about 20 to about 80 weight percent in yet other embodiments.

In one or more embodiments, the curable polymer may be a diene pre-polymer such as polybutadiene which forms, in the presence of a reactive diluent(s), a composite material that exhibits an ability to absorb energy and deform without fracturing, i.e., the material exhibits toughness, as well as a degree of rigidity. As used herein, a “diene pre-polymer” may refer to a polymer resin formed from at least one aliphatic conjugated diene monomer. Examples of suitable aliphatic conjugated diene monomers include C₄ to C₉ dienes such as butadiene monomers, e.g., 1,3-butadiene, 2-methyl-1,3-butadiene, and 2-methyl-1,3-butadiene. Homopolymers or blends or copolymers of the diene monomers may also be used. In yet another embodiment, one or more non-diene monomers may also be incorporated in the diene pre-polymer, such as styrene, acrylonitrile, etc.

In various embodiments, the diene pre-polymers may have a number average molecular weight broadly ranging from about 500 to 10,000 Da. However, more particularly, the number average molecular weight may range from about 1000 to 5000 Da, and even more particularly, from about 2000 to 3000 Da. For diene resins, microstructure refers to the amounts 1,2-versus 1,4-addition (for example) and the ratio of cis to trans double bonds in the 1,4-addition portion. The amount of 1,2-addition is often referred to as vinyl content due to the resulting vinyl group that hangs off the polymer backbone as a side group. The vinyl content of the diene prepolymer used in accordance of the present disclosure may range from about 5% to about 90%, and from about 50% to 85% in a more particular embodiment. The ratio of cis to trans double bonds may range from about 1:10 to about 10:1. Various embodiments of the above described prepolymers may be non-functionalized; however, functionalization such as hydroxyl terminal groups or malenization may be used in some embodiments. For example, the average number of reactive terminal hydroxyl groups or maleic anhydride functionalization per molecule may range from about 1 to 3, but may be more in other embodiments.

Selection of the particular pre-polymer may be based on several factors, for example, such as the degree of toughness versus rigidity desired for the particular application, the amount of crosslinking desired, viscosity in a pre-cured state, flashpoint, etc.

The diene pre-polymer may be used in an amount ranging from about 5 to about 50 weight percent, based on the total weight of the formulation, from about 8 to about 35 weight percent in other embodiments, and from about 10 to about 30 weight percent in yet other embodiments.

In one or more embodiments, the curable polymer may be selected from the group of styrenic polymer, acrylate polymers or mixtures thereof. For example, styrenic based polymers may be mixed in various ratios with acrylate based polymers, in the presence of various additives. In such embodiments, the ratio between the styrenic based polymer and the acrylate polymer may vary between 50:50 to 70/30.

According to the present embodiments, curable polymeric solutions may be used for the preparation of a lost circulation pill. For example, in one embodiment, a lost circulation pill may be prepared using 95-99% curable polymer, barite, Safecarb 2, a wetting agent (such as Versawet, available from MI SWACO, Houston, Tex.) and 1-5% activator. The activator may be selected from the group of organic peroxides, such as organic dialkyl peroxides. For example, in one embodiment, the organic dialkyl peroxide is Luperox 801, which is used as an initiator, and is available from Arkema.

The polymers as described above may be combined with a reactive diluent. The reactive diluents may be included in the formulation to increase the tensile strength and flexural strength of the cured solid composite material. Increased tensile and flexural strength of the composite material may be due to the steric hindrance of the reactive diluents within the polymer network after curing. The reactive diluent may be a monomer or blend of monomers that are polymerizable by free-radicals. Examples of such monomers include the following: vinyl monomers such as styrene derivatives (styrene, vinyl toluene, alpha methyl styrene, divinyl benzene, tertiary butyl styrene, diallyl phthalate, isocyanurate and others); acrylates and methacrylates (monofuntional, multifunctional, hydroxyl functionalized, amine functionalized, carboxylic acid functional, polyether polyol extended, all esters of acrylic acid or methacylic acid, and others); vinyl ester monomers and combinations thereof, as well as all related derivatives that are cross-linkable through a free radical polymerization reaction.

Particular embodiments may use a a cycloalkyl ester of (meth)acrylate monomer having a substituted or unsubstituted (excluding polar or hydrophilic substituents), cyclic or bicyclic ring structure at the alpha or beta carbon position. Particular substituents may include C1-C3 alkyl groups. Alternative reactive diluents that may be used instead of or in addition to (meth)acrylates include other vinyl monomers capable of anionic addition polymerization (without chain transfer or termination) that contain non-polar substituent(s) on the vinyl group that can stabilize a negative charge through delocalization such as styrene, epoxide, vinyl pyridine, episulfide, N-vinyl pyrrolidone, and N-vinyl caprolactum.

The reactive diluent may be used in an amount ranging from about 10 to about 90 weight percent, based on the total weight of the composite, from about 20 to about 80 weight percent in other embodiments, and from about 30 to about 70 weight percent in yet other embodiments.

Accelerators and retardants may optionally be used to control the cure time of the composite. For example, an accelerator may be used to shorten the cure time while a retardant may be used to prolong the cure time. In some embodiments, the accelerator may include an amine, a sulfonamide, or a disulfide, and the retardant may include a stearate, an organic carbamate and salts thereof, a lactone, or a stearic acid. Also, additives such as emulsifiers, stabilizers, plasticizers, adhesion promoters, viscosifiers, fillers, corrosion inhibitors, oxygen scavengers or sodium or calcium scavengers may be added to enhance or tailor the composite properties.

In some embodiments, the curable polymeric solution, reactive diluents, and initiator may be mixed prior to injection of the formulation into the well formation. As described above, the curable polymeric solution may be weighted with a blend of particles having different particle sizes and/or specific gravity which are suspended in the base fluid. The mixture may be injected while maintaining a low viscosity, prior to polymerization formation, such that the composite may be formed downhole. For example, a first mixture containing a curable polymeric solution such as a loss circulation pill and/or reactive diluent may be injected into the wellbore and into the lost circulation zone. For example, the liquid components may be pumped into a wellbore which traverses a loosely consolidated formation, and allowed to cure, thereby forming a polymeric network which stabilizes the formation and the wellbore as a whole.

The blends of particles as described herein may be added to a wellbore fluid (containing the curable polymeric solution described above along with optional diluents, initiators, etc.) as a weighting agent in a dry form or concentrated as a slurry in either an aqueous medium or as an organic liquid. As is known, an organic liquid should have the environmental characteristics required for additives to oil-based wellbore fluids. With this in mind, the oleaginous fluid may have a kinematic viscosity of less than 10 centistokes (10 mm²/s) at 40° C., and, for safety reasons, a flash point of greater than 60° C. Suitable oleaginous liquids are, for example, diesel oil, mineral or white oils, n-alkanes or synthetic oils such as alpha-olefin oils, ester oils, mixtures of these fluids, as well as other similar fluids known to one of skill in the art of wellbore fluid formulation.

Base Fluid

The blends of particles as described herein may be used in various types of wellbore fluids. The applications of the wellbore fluids as described herein dictate the composition of the wellbore fluids. For example, wellbore fluids containing blends of weighting agents having different particle sizes and/or specific gravity suspended in the base fluid may be used as cementing fluids, fracturing fluids, displacement fluids or spacers. It is also envisioned that wellbore fluids of the present disclosure may be used as lost circulation pills. In such embodiments, a blend of weighting agents and inert solid materials may be dispersed or suspended in a base fluid that includes a curable polymeric solution. It is also envisioned that a combination of different wellbore fluids to be used. For example, a spacer fluid of the present disclosure may be used adjacent to a lost circulation pill. Such alternative uses, as well as other uses, of the present fluid should be apparent to one of skill in the art given the present disclosure. In accordance with one embodiment, the blends of particles may be used in a wellbore fluid formulation. The wellbore fluid may be a water-based fluid, a direct emulsion, an invert emulsion, or an oil-based fluid.

Water based wellbore fluids may have an aqueous fluid as the base liquid. The aqueous fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to, alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, silicon, and lithium, and salts of chlorides, bromides, carbonates, iodides, chlorates, bromates, formates, sulfates, phosphates, nitrates, oxides, and fluorides. Salts that may be incorporated in a brine include any one or more of those present in natural seawater or any other organic or inorganic dissolved salts. Additionally, brines that may be used in the wellbore fluids disclosed herein may be natural or synthetic, with synthetic brines tending to be much simpler in constitution. In one embodiment, the density of the wellbore fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

The oil-based wellbore fluids and/or invert emulsions based wellbore fluids may include an oleaginous continuous phase and non-oleaginous discontinuous phase. The oleaginous fluid may be a liquid, such as a natural or synthetic oil, and in some embodiments is selected from the group including diesel oil, mineral oil, a synthetic oil, such as hydrogenated and unhydrogenated olefins including polyolefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

For invert emulsions, the concentration of the oleaginous fluid should be sufficient so that an invert emulsion forms, and may be less than about 99% by volume of the invert emulsion. In one embodiment, the amount of oleaginous fluid may range from about 30% to about 95% by volume of the invert emulsion fluid. The oleaginous fluid, in one embodiment, may include at least 5% by volume of a material selected from the group including esters, ethers, acetals, dialkylcarbonates, hydrocarbons, and combinations thereof.

The non-oleaginous fluid used in the formulation of the invert emulsion fluid disclosed herein is a liquid and may be an aqueous liquid. In one embodiment, the non-oleaginous liquid may be selected from the group including sea water, a brine containing organic and/or inorganic dissolved salts, liquids containing water-miscible organic compounds and combinations thereof. The amount of the non-oleaginous fluid is typically less than the theoretical limit needed for forming an invert emulsion. Thus, in one embodiment, the amount of non-oleaginous fluid may be less that about 70% by volume. In another embodiment, the non-oleaginous fluid is from about 5% to about 60% by volume of the invert emulsion fluid. The fluid phase may include either an aqueous fluid or an oleaginous fluid, or mixtures thereof. The fluids disclosed herein are especially useful in the drilling, completion and work over of subterranean oil and gas wells.

Other additives that may be included in the wellbore fluids disclosed herein include for example, wetting agents, organophilic clays, viscosifiers, fluid loss control agents, surfactants, dispersants, interfacial tension reducers, pH buffers, mutual solvents, thinners, thinning agents and cleaning agents. The addition of such agents should be well known to one of ordinary skill in the art of formulating drilling fluids and muds.

Conventional methods may be used to prepare the wellbore fluids disclosed herein in a manner analogous to those normally used, to prepare conventional water- and oil-based wellbore fluids. In one embodiment, a desired quantity of water-based fluid and a suitable amount of at least a blend of particles having different sizes and/or specific gravity are mixed together and the remaining components of the wellbore fluid added sequentially with continuous mixing. In another embodiment, a desired quantity of oleaginous fluid, such as a base oil, a non-oleaginous fluid, and a suitable amount of the at least a blend of particles having different sizes and/or specific gravity are mixed together and the remaining components are added sequentially with continuous mixing. An invert emulsion may be formed by vigorously agitating, mixing or shearing the oleaginous fluid and the non-oleaginous fluid.

The properties of the wellbore fluids disclosed herein may allow for the wellbore fluid to meet the requirements of low sag during drilling, including horizontal drilling, and low settling of drilled solids and weighting agents when the drilling fluid is static.

Upon mixing, the fluids of the present embodiments may be used in wellbore operations, such as base brines in drilling fluids, completion, fluid loss treatment or gravel packing operations. Such operations are known to persons skilled in the art and involve pumping a wellbore fluid into a wellbore through an earthen formation and performing at least one wellbore operation while the wellbore fluid is in the wellbore.

One embodiment of the present disclosure involves a method of treating a wellbore. In one such an illustrative embodiment, the method involves pumping a wellbore fluid into the wellbore and performing at least one wellbore operation while the wellbore fluid is in the wellbore. In various embodiments, the wellbore fluid may include a base fluid and a blend of weighting agents having different particle sizes and/or specific gravity suspended in the base fluid. As noted above, such wellbore fluids may be used as cementing fluids, fracturing fluids or spacers.

In yet another embodiment, the wellbore fluids may include a blend of weighting agents and/or inert solid materials dispersed or suspended in a base fluid. As noted above, the base fluid may include a curable polymeric solution, or the base fluid is the curable polymeric solution itself. In such embodiments, after pumping the wellbore fluid into the wellbore, the curable polymeric solution is allowed to cure while the wellbore fluid is static in the wellbore. Next, at least one wellbore operation may be performed after curing of the curable polymeric solution while the wellbore fluid is in the wellbore. In such embodiments, the blend of weighing agents and inert solid materials having different particle sizes and/or specific gravity suspended in the base fluid may maintain suspension of the solid particles in the wellbore fluid while the wellbore fluid is static during curing of the curable polymeric solution. In such embodiments, the wellbore fluid may be used as a curable lost circulation pill. In an embodiment of the present disclosure, the wellbore operation may be a drilling operation, when drilling is performed through the cured polymer. However, the wellbore fluids as described herein may be formulated depending on the desired application.

### Examples

The following examples are presented to further illustrate the properties of the wellbore fluids of the present disclosure, and should not be construed to limit the scope of the disclosure, unless otherwise expressly indicated in the appended claims. All ratios are in terms of volume.

Two fluid systems, A and B, were formulated according to the present disclosure, using a polymer, EMI-1922 which is an acrylate based polymer with additives. The density of both systems was 12.0 lb/gal. For a basic evaluation, sag testing was performed at 120° F. The results are summarized in Table 1. SAFECARB 2® is a calcium carbonate bridging solid with a specific gravity SG of 2.6 g/cm³, while MI WATE™ is a 4.1 g/cm³ SG barite, all of which are available from MI SWACO (Houston, Tex.).

TABLE 1
Formulation A

| 100% M-I | 2 hours | 16 hours |
|---|---|---|
| WATE ™ | at 120° F. | at 120° F. |
| Brown mixture | Brown mixture | Brown mixture |
| with immediate | with | with significantly |
| (minimal) | increased | increased sagging. Fluid |
| sagging initially. | sagging. | failed to suspend |
| | | solids in 16 hours. |

Formulation B

| 100% | 2 hours | 16 hours |
|---|---|---|
| SAFECARB 2 | at 120° F. | at 120° F. |
| White mixture | White | White mixture |
| with no | mixture with | with increased |
| sagging. | minimal | sagging. Fluid successfully |
| | sagging. | suspends solids, but fluid is |
| | | too viscous for certain |
| | | applications. |

To fully assess the properties of formulation B, rheology was measured using a Fann 35 Viscometer at the rpm indicated. The rheological properties at different temperatures of the formulation B are presented below in Table 2. According to the experimental findings, formulation B is too viscous for specific applications.

TABLE 2
12.0 lb/gal Rheologies
100% SAFECARB 2 in KIC-15-046

| | 40° F. | 70° F. | 120° F. |
|---|---|---|---|
| 600 rpm | >300 | >300 | 192 |
| 300 rpm | >300 | 198 | 104 |
| 200 rpm | 230 | 137 | 73 |
| 100 rpm | 124 | 75 | 42 |
| 6 rpm | 19 | 14 | 10 |
| 3 rpm | 14 | 12 | 8 |
| PV | — | — | 88 |
| YP | — | — | 16 |

Various formulations were prepared in accordance with the present disclosure. Specifically, blends of particles with different ratios SAFECARB® 2:MI WATE™ were used for the preparation of different wellbore fluid formulations.

The polymer used was KIC-15-046. Table 3, below, summarizes the prepared formulations and the appearance of the fluid formulations. All the ratios are in terms of volume. According to the experimental findings, a ratio of 50:50 of SAFECARB 2®:MI WATE™ is considered to be the lower limit due to suspension, while a ratio of 90:10 SAFECARB® 2:MI WATE™ is considered the upper limit due to viscosity.

Table 4, below, shows the rheological properties of a wellbore fluid formulation containing a ratio of 70:30 of SAFECARB 2®:M-I WATE in KIC-15-046. According to the experimental findings, for a wellbore fluid having 12.0 lb/gal density, a ratio of 70:30 of SAFECARB 2®:M-I WATE™ provides great suspension of solids along with good fluid properties.

TABLE 3
Formulations
(SAFECARB 2 ®: M-I WATE ™)

| | | | | |
|---|---|---|---|---|
| 30:70 | 40:60 | 50:50 | 60:40 | 70:30 |

Initial appearance

| | | | | |
|---|---|---|---|---|
| Grey | Grey | Grey | Grey | Grey |
| mixture with | mixture | mixture | mixture | mixture |
| insignificant | with | with | with | with no |
| sagging. | minimal | increased | minute | perceptible |
| | sagging. | sagging. | sagging. | sagging. |

Appearance after 2 hours at 120° F.

| | | | | |
|---|---|---|---|---|
| Light grey | Light grey | Light grey | Light grey | Light grey |
| mixture with | mixture | mixture | mixture | mixture |
| increased | with | with | with | with no |
| sagging. | minimal | minimal | minute | perceptible |
| | sagging. | sagging. | sagging. | sagging. |

Appearance after 6 hours at 120° F.

| | | | | |
|---|---|---|---|---|
| Light grey | Light grey | Light grey | Light grey | Light grey |
| mixture with | mixture | mixture | mixture | mixture |
| major | with | with | with | with no |
| sagging. | moderate | minimal | minute | perceptible |
| | sagging. | sagging. | sagging. | sagging. |

Appearance after 20 hours at 120° F.

| | | | | |
|---|---|---|---|---|
| Light grey | Light grey | Light grey | Light grey | Light grey |
| mixture with | mixture | mixture | mixture | mixture |
| full sagging. | with nearly | with major | with | with |
| | full | sagging. | minimal | insignificant |
| | sagging. | | sagging. | sagging. |

TABLE 4
Rheological properties.
12.0 lb/gal Rheologies
70:30 SAFECARB 2 ®: MI WATE ™ in
KIC-15-046

| | 40° F. | 70° F. | 120° F. |
|---|---|---|---|
| 600 rpm | >300 | 219 | 113 |
| 300 rpm | 179 | 118 | 61 |
| 200 rpm | 124 | 83 | 44 |
| 100 rpm | 67 | 46 | 26 |
| 6 rpm | 11 | 9 | 6 |
| 3 rpm | 8 | 7 | 5 |
| PV | — | 101 | 52 |
| YP | — | 17 | 9 |

Advantageously, embodiments of the present disclosure provide wellbore fluids that include a sag resistant pumpable composition. As described above, the blends of particles having different sizes and/or specific gravity, may exhibit a reduced tendency to sag under either static conditions (such as during curing a polymeric solution), or dynamic conditions. Thus, the combination of particles of different sizes and/or specific gravity reconciles the two objectives of lower viscosity and minimal sag.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A wellbore fluid, comprising:
a base fluid; and
a blend of weighting agents having different particle sizes and/or specific gravity suspended in the base fluid.

2. The wellbore fluid of claim 1, wherein the weighting agents have at least a bimodal particle size distribution.

3. The wellbore fluid of claim 2, wherein each mode of weighting agents from the bimodal particle size distribution has a different specific gravity.

4. The wellbore fluid of claim 3, wherein a first mode of small weighting agents and a second mode of large weighting agents are present in a ratio, by volume, that ranges from 40:60 to 90:10.

5. The wellbore fluid of claim 4, wherein the weighting agents have a particle size that ranges from 1 μm to 3000 μm.

6. The wellbore fluid of claim 5, wherein the weighting agents have a specific gravity that ranges from 2.1 g/cm³ to 5.3 g/cm³.

7. The wellbore fluid of claim 1, wherein the base fluid is selected from the group of aqueous fluids and non-aqueous fluids.

8. The wellbore fluid of claim 7, wherein the base fluid is a curable polymeric solution.

9. The wellbore fluid of claim 8, wherein the curable polymeric solution is selected from the group of thermosetting polymers that are activated via radical polymerization, temperature or pH.

10. The wellbore fluid of claim 9, wherein the blend of weighting agents is selected to maintain suspension of the solid particles in the wellbore fluid while the wellbore fluid is static during curing of the curable polymeric solution.

11. A wellbore fluid, comprising:
a base fluid comprising a curable polymeric solution; and
a blend of particles having different particle sizes and/or specific gravity suspended in the base fluid;
wherein the blend of particles is selected to maintain suspension of the solid particles in the wellbore fluid while the wellbore fluid is static during curing of the curable polymeric solution.

12. The wellbore fluid of claim 11, wherein the size of the particles ranges from 30 nm to 3000 μm.

13. The wellbore fluid of claim 11, wherein the particles are selected from the group of weighing agents and inert solid materials used as suspension aids.

14. The wellbore fluid of claim 11, wherein the curable loss circulation material is selected from the group of thermosetting polymers that are activated via radical polymerization, temperature and pH.

15. The wellbore fluid of claim 11, wherein the wellbore fluid is a curable lost circulation pill.

16. A method of treating a wellbore, comprising:
pumping a wellbore fluid into the wellbore, the wellbore fluid comprising:
a base fluid; and
a blend of weighting agents having different particle sizes and/or specific gravity suspended in the base fluid.

17. The method of claim 16, wherein the base fluid is selected from the group of aqueous and non-aqueous fluids.

18. The method of claim 17, wherein the base fluid is a curable polymeric solution.

19. The method of claim 18, wherein the curable polymeric solution is selected from the group of thermosetting polymers that are activated via radical polymerization, temperature or pH.

20. The method of claim 16, wherein the blend of weighting agents further comprises inert solid materials used as suspension aids having different particle sizes and/or specific gravity.

21. The method of claim 20, wherein the weighting agents and the inert solid materials having different particle sizes and/or specific gravity are selected to maintain suspension of the solid particles in the wellbore fluid while the wellbore fluid is static during curing of the curable polymeric solution.

22. The method of claim 21, wherein the weighting agents and the inert solid materials used as suspension aids are present in the blend in a ratio of small particles in combination with large particles that ranges from 40:60 to 90:10 in terms of volume.

23. The method of claim 22, wherein the weighting agents and the inert solid materials used as suspension aids have a particle size that ranges from 30 nm to 3000 μm.

24. The method of claim 23, wherein the particle size of the weighting agents ranges from 1 μm to 3000 μm.

25. The method of claim 16, wherein the weighting agents have a specific gravity that ranges from 2.1 g/cm³ to 5.3 g/cm³.

26. The method of claim 16, further comprising:
allowing the curable polymeric solution to cure while the wellbore fluid is static in the wellbore; and
performing, after curing of the curable polymeric solution at least one wellbore operation while the wellbore fluid is in the wellbore.

27. The method of claim 26, wherein the wellbore operation is a drilling operation, drilling through the cured polymer.
